(19) United States
(12) Patent Application Publication
(10) Pub. No.: US 2004/0218271 A1
(43) Pub. Date: Nov. 4, 2004

(54) Retardation element made from cubic crystal and an optical system therewith

(75) Inventors: Juergen Hartmaier, Oberkochen (DE); Damian Fiolka, Oberkochen (DE); Markus Zenzinger, Ulm (DE); Birgit Mecking, Aalen (DE); Olaf Dittmann, Bopfingen (DE); Toralf Gruner, Chemnitz (DE); Vladimir Kamenov, Oberkochen (DE); Martin Brunotte, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 10/758,118

(22) Filed: Jan. 16, 2004

Related U.S. Application Data
(63) Continuation-in-part of application No. PCT/DE02/02392, filed on Jun. 25, 2002.

(30) Foreign Application Priority Data
Jul. 18, 2001 (DE) 101 33 842.2
Jan. 16, 2003 (DE) 103 01 548.5
Feb. 14, 2003 (WO) PCT/EP03/01475

(51) Int. Cl. G02B 5/30; G02B 27/28

(52) U.S. Cl. 359/494

(57) ABSTRACT

Centimeter thick plates or lenses made from calcium fluoride or barium fluoride with beam propagation in the direction of the <110> crystal direction or of a main axis equivalent thereto are provided as retardation elements for the deep ultraviolet. They can be installed in an unstressed fashion. In a particular embodiment a retardation plate comprises a birefringent crystal plate which has an entry face and an exit face for incident and emerging light, respectively. A form-birefringent dielectric layer structure is applied to the entry and/or exit face. It may, for example, be a periodic sequence of at least two layers with alternating refractive indices. The retardation plate is suitable for ultraviolet light, and permits a large range of angles of incidence. Retardation elements according to the invention are particularly suitable for microlithography at 157 nm.

This application is a continuation-in-part application to international patent application PCT/DE02/02392 filed on Jun. 25, 2002 and claiming priority of German patent application DE 10133842.2 filed on Jul. 18, 2001. Priority is further claimed from international patent application PCT/EP03/01475 filed on Feb. 14, 2003 and claiming priority of German patent application DE 10301548.5 filed on Jan. 16, 2003.

### BACKGROUND OF THE INVENTION

1. Field of the Invention

The invention relates to a retardation element made from cubic alkaline-earth metal fluoride crystal, and to optical systems having such retardation elements.

The invention also relates to a retardation plate with a birefringent crystal plate, which has an entry face and an exit face for incident and emerging light, respectively.

2. Description of the Related Art

The term retardation plates, or phase plates, refers to optically birefringent plane-parallel plates, which generally consist of an optically uniaxial crystal. The surfaces of the retardation plate are parallel to the optic axis of the crystal, so that a normally incident wave is split into two waves oscillating mutually orthogonally with a phase difference dependent on the plate thickness. The term “optic axis” as used above refers to the pricipal crystallographic axis of the crystal in which light has the same speed regardless of the state of polarization. Behind the retardation plate, the light is combined to form a polarisation state which depends on the plate thickness. If, for example, this thickness is chosen so that the phase difference corresponds to one quarter of the wavelength A of the incident light, then the retardation plate is referred to as a quarter-wave plate (λ/4 plate), which converts linearly polarised light into elliptically or circularly polarised light, and vice versa. If, however, the phase difference introduced between the polarisation directions by the retardation plate is a half wavelength, then this is referred to as a half-wave plate, which, for example, can be used to invert the handedness of elliptically or circularly polarised light.

Retardation plates are used, for example, in catadioptric projection objectives of microlithographic projection illumination systems. Such systems are nowadays operated with such short-wave ultraviolet light that very many birefringent crystals are no longer viable as a material for the retardation plates owing to excessive adsorption.

Magnesium fluoride is in principle suitable for this wavelength range, but it has such a high birefringence that very stringent requirements need to be placed on the manufacturing tolerances. Indeed, even very minor deviations from the intended thickness lead to a noticeable deviation from the desired phase difference between the orthogonal polarisation directions. Owing to the high birefringence of magnesium fluoride, it is furthermore technologically difficult to produce zeroth-order retardation plates, in which the phase difference being introduced is exactly λ/4 and not, for instance, (n+¼)λ, with n=1, 2, . . . . Such zeroth-order retardation plates are in fact so thin that both their production and their handling in optical instruments entail significant problems. Zeroth-order retardation plates are generally preferred because their function depends less strongly on the angle at which the light strikes the retardation plate. This aspect is of particular importance in the aforementioned projection objectives, since these often have a numerical aperture of more than 0.3, so that large angles of incidence can occur.

Retardation plates are disclosed, for example, in the applicant's U.S. Pat. No. 6,191,880 B. A retardation element is described there in the form of a retardation plate, that is to say a birefringent plate that effects a phase shift between two mutually orthogonally polarized transiting beams, and can be designed, for example, as a λ/4 plate or λ/2 plate. The plate consists of calcium fluoride, which exhibits strain birefringence owing to external forces or to the production process. Nothing is stated there regarding crystal orientation.

Because of their symmetry, cubic crystals do not normally exhibit birefringence.

Residual strain birefringence induced by the production of optical elements made from calcium fluoride is disclosed in U.S. Pat. No. 6,201,634 B1.

Classical birefringent crystals, such as magnesium fluoride, exhibit birefringence at such a high level that only very thin plates are required, but these throw up technical problems, as may be gathered, for example, from DE 197 04 936 A (U.S. Ser. No. 09/017,159) and the applicant's U.S. Pat. No. 6,084,708 B. Although inherently possible and customary thicker retardation plates with a path difference (n+¼), that is to say λ retardation plates of nth order, are thicker, they require the same narrow thickness tolerance and have a much lower angular tolerance for light.

Many other known materials for retardation elements are not available in the ultraviolet region from 200 to 150 nm and below, because of excessively high absorption.

It is known from the Internet publication “Preliminary Determination of an Intrinsic Birefringence in CaF₂” by John H. Burnett, Eric L. Shirley and Zachary H. Levine, NIST Gaithersburg Md. 20899 USA (posted on 07.05.01) that calcium fluoride single crystals also exhibit birefringence that is not induced by strain and is therefore intrinsic. The measurements presented there show that a birefringence of (6.5±0.4) nm/cm occurs at a wavelength of λ=156.1 nm in the case of beam propagation in the direction of the <110> crystal axis. Measurements by the applicant indicated 11 nm/cm. By contrast, birefringence is low in the other crystal axis directions.

### SUMMARY OF THE INVENTION

It is one object of the invention to provide an alternative design of retardation elements that is suitable for wavelengths in the region of 200 to 150 nm and below, and permits very exact functioning in conjunction with a moderate outlay on production.

It is another object to provide favorable optical systems with such retardation elements.

It is yet another object of the invention to provide a retardation plate of the type mentioned in the introduction, which is suitable for use in microlithographic projection illumination systems. In particular, the retardation plate is intended to have a high transparency in the ultraviolet radiation range, to be simple to produce and to handle, and furthermore to be usable even in wide-aperture optical systems.

High-quality retardation elements for this wavelength region are required, for example, in microlithography projection exposure machines, in particular in conjunction with catadioptric projection objectives. They are urgently required for projection objectives with polarization beam splitters as quarter-wave retardation elements between beam splitter and concave mirror. In the case of other types having deflecting mirrors with a deflection of approximately 90°, the reflection near the Brewster angle leads to polarization-dependent reflectivities that must be compensated.

The objects mentioned above and other objects are achieved, according to one formulation of the invention, by means of a retardation element having an optical axis and consisting of an alkaline-earth metal fluoride crystal having a <110> crystal axis, the optical axis pointing approximately in the direction of the <110> crystal axis of the crystal or a main crystal axis equivalent thereto.

The term “optical axis” as used here generally refers to a direction or axis defined in the optical element wherein the direction or axis lies parallel to the optical axis of the optical system in which the optical element is mounted. If, for example, the optical element is a rotationally symmetric lens, then the optical axis normally corresponds to the axis of symmetry of the lens. If the optical element is a plane parallel plate which is intended to be mounted such that the parallel entry and exit faces of the plate are substantially perpendicular to the optical axis of the optical system in which the plate is mounted, then the optical axis refers to a direction substantially perpendicular to the entry and exit faces. In other words: the optical axis of an optical element coincides generally with the direction of light running essentially parallel to the optical axis of the optical system in which the optical element is mounted. This light will transit the optical element essentially parallel to the optical axis of the optical element.

Advantageous developments are specified in dependent claims. The wording of all the claims is incorporated in the description by reference.

In accordance with one aspect the invention, the residual birefringence of fluoride crystal material with intrinsic birefringence, in particular of calcium fluoride, which has a maximum for beam penetration parallel to the <110> crystal axis, or parallel to a main axis of the crystal equivalent thereto, and which has hitherto been regarded as a problem of lens systems made from this material, is used in a targeted fashion as operating mechanism for retardation elements (retarders). Because of the relatively low birefringence, the element can be several millimeters or several centimeters thick, however, the absolute thickness is also important for very accurate retardations only in a range that is not problematic for the production of optical elements.

Apart from this intrinsic birefringence, a relatively high value is also attached to strain birefringence caused by production conditions in the direction claimed in accordance with U.S. Pat. No. 6,201,634 B. The thickness of such a retardation element with a desired retardation, for example, as a quarter-wave retarder, can be determined from the measured value of the birefringence of the concrete material charge, and both causes of birefringence can thereby be taken into account.

In addition, the inventors have established that barium fluoride single crystal likewise exhibits such birefringence, although with about twice the value of approximately 25 nm/cm. Consequently, barium fluoride with the same orientation is also suitable, and has the advantage of about half the thickness.

It is clear that all other crystals are also suitable in the same way if they exhibit a similar birefringence. However, these values are not presently known for other fluoride crystals that are transparent in the deep ultraviolet. A specification with reference to the strain birefringence induced by production is known only in U.S. Pat. No. 6,201,634 B for strontium fluoride.

By comparison with extremely thin MgF₂ retardation plates, the use of CaF₂ or BaF₂ has the advantage that the thicknesses can be in the cm range. This greatly simplifies the reduction of the retardation elements.

Further embodiments are the subject matter of the subclaims.

The half-wave plates and the quarter-wave plates are important designs of the retardation elements, the design according to the invention consisting of materials of relatively weak birefringence being particularly suitable for producing plates of zeroth order. With the latter, the path difference is equal to (0+¼)λ or (0+½)λ, and so a non-effective path difference of a multiple of the wavelength is not introduced in addition. This is unavoidable for plates made from magnesium fluoride in order to achieve plate thicknesses that can be handled, but it does effect a limitation of the angular acceptance.

Stress-free bearing is possible. This means, for example, that a retardation plate can be supported using normal mounts, such as are also used for lenses, filter plates and the like. Expensive apparatuses for homogeneous introduction of force in accordance with U.S. Pat. No. 6,084,708 B, for example, are eliminated just as are problems in the holding of particularly thin elements.

Particularly advantageous are designs wherein a retardation plate bears a functional face. It is possible without effectively influencing the retardation or the polarization rotation to provide one or both end faces with a structure that acts refractively or diffractively. Fresnel lenses, zone plates, refractive or diffractive grid plates and the like with pattern heights up to the millimeter range can therefore be provided without an additional component. Such components can be used, for example, in the illumination system of a microlithography projection exposure machine to simultaneously influence the polarization distribution and to increase the photoconductance (geometric light guidance value, etendue).

It is also possible for one or both end faces (entry face and/or exit face) to be curved spherically or aspherically or as a free-form surface, such that the retardation element can simultaneously contribute to the correction of an optical system.

It is also possible, for example, for a substantially curved meniscus to serve as retardation element according to the invention when the light path corresponds sufficiently accurately only to the desired retardation over the entire cross section. One or both bounding faces or end faces can also have a substantial curvature such that the retardation element can form a lens, preferably in the shape of a meniscus. The retardation element can therefore also have positive or negative refracting power. The integration of the retardation effect occupying the foreground here with a lens action can be used for designs that save material and are of favorable design. Such lenses can also be useful in purely dioptric optical systems, in particular in microlithography projection objectives or illumination systems, and in catadioptric systems.

The intrinsic birefringence of the said materials has its maximum value in <110> crystal directions. For beams that run through the material at an angle to <110> directions, the magnitude of the intrinsic birefringence exhibits a parabolically decreasing profile with growing angle, whilst the axes of the intrinsic birefringence approximately retain the direction. This circumstance can be used to smooth out the retardation effect over the entire transirradiated face. For this purpose, it is possible in the case of a retardation element with two optical faces, for the shape of the optical faces and the installation position of the retardation element to be adapted to one another in such a way that the light path of beams inside the retardation element is larger between the optical faces the larger the angle is between the beam and the optical axis or a <110> direction of the retardation element. Consequently, beams with a greater angle to the <110> direction have to cover a longer light path, and so the retardation effect that results from the product between intrinsic birefringence and light path becomes approximately uniform over the entire active surface.

This concept will be explained later with the aid of exemplary embodiments of catadioptric projection objectives in the case of which a retardation element comprises a lens or lens group arranged in the vicinity of the concave mirror, made from <110>-oriented fluoride crystal and which is in the shape of a meniscus overall and has a negative refracting power. A lens or lens group of this type arranged in the vicinity of the pupil can have a largely constant or only slightly varying retardation effect over the entire pupil. The integration of a retardation element with a lens element by producing a lens element (provided with refracting power) made from <110>-oriented single crystal with intrinsic birefringence (for example, calcium fluoride single crystal or barium fluoride single crystal) can be useful for all catadioptric or dioptric projection objectives. A suitably dimensioned lens or lens group with the retardation effect of a λ/4 plate can be used as (a functionally necessary) retarder, for example in systems with a polarization-selective beam splitter, between beam splitter and concave mirror and/or at another point of a projection objective, for example, between object plane and beam splitter and/or between beam splitter and image plane.

According to another aspect of the invention, the objects mentioned above and other objects are achieved, in the case of a retardation plate of the type mentioned in the introduction, by the fact that a crystal plate consists of an alkaline-earth metal fluoride, in particular of fluorspar, and its optical axis is aligned at least approximately in the direction of the <110> crystal axis or of a principal crystal axis equivalent thereto, and by the fact that a form-birefringent layer structure is applied to the entry and/or exit face.

The optical axis will generally coincide with a direction substantially perpendicular to the entry and exit face of the plate.

This aspect of the invention is based, on the one hand, on the fact that very many alkaline-earth metal fluoride crystals, for example fluorspar crystals (CaF₂) or barium fluoride crystals (BaF₂) have an intrinsic birefringence for beam propagation in the direction of the <110> crystal axis. The birefringence for beam propagation along the other crystal axis directions, however, is small. Since these crystals have a high transparency in the ultraviolet wavelength range, they are suitable in particular for use in projection objectives of microlithographic projection illumination systems. Since the birefringence of these crystals is also comparatively small in the <110> direction, it is thereby possible to produce zeroth-order retardation plates which are not as thin as, for example, retardation plates made of magnesium fluoride. Less stringent requirements are therefore placed on the manufacturing tolerances relating to the plate thickness.

It has furthermore been found that, in form-birefringent layer structures such as those disclosed by U.S. Pat. No. 6,384,974 B1, for example, the angular dependency of the birefringent effect is different compared with alkaline-earth fluoride crystals, and is in fact essentially reversed: although—as already mentioned above—the birefringence decreases with increasing angles of incidence in such crystals, the situation is precisely the opposite in the form-birefringent layer structure, that is to say the birefringence increases with increasing angle of incidence. In this way, the decreasing birefringence of the crystals at larger angles of incidence is compensated for at least partially by the birefringence of the layer structure, which then increases. With a suitable configuration of the layers, it is even possible to achieve a substantially angle-independent phase difference between orthogonally polarised components of the light.

Such a retardation plate is therefore also suitable for very wide-aperture objectives in projection illumination systems.

The form-birefringent layer structure may be configured as a periodic sequence of at least two layers with alternating refractive indices. The thicknesses of the layers must then be smaller than the wavelength for which the retardation plate is designed. The thicknesses of the layers are advantageously less than ⅕ or even 1/10 of this wavelength. In fact, the smaller the thicknesses of the layers are compared with the wavelength of the incident light, the more the layer structure acts as a homogeneous uniaxial birefringent medium for incident light. It is furthermore preferable for all the layers to have the same thickness.

The foregoing and further features proceed from the description and the drawings as well as from the claims, wherein the individual features can be implemented in each case on their own or several in the form of subcombinations in the case of embodiments of the invention and in other fields, and can constitute advantageous designs which are also capable of protection themselves.

### BRIEF DESCRIPTION OF THE DRAWINGS

FIG. 1 shows a section of a catadioptric projection objective in the case of which an embodiment of a meniscus-shaped retardation element with negative refractive power is arranged between a beam splitter surface and a concave mirror; and

FIG. 2 shows a schematic of the catadioptric objective part of a projection objective with a physical beam splitter;

FIG. 3 represents a disc-shaped retardation plate in a section along its symmetry axis; and

FIG. 4 shows a refractive-index ellipsoid for a layer structure which is part of the retardation plate shown in FIG. 3.

### DETAILED DESCRIPTION OF THE PREFERRED EMBODIMENTS

Important aspects of the invention will firstly be explained in more detail with the aid of exemplary embodiments of quarter-wave plates by comparison with designs made from magnesium fluoride.

A quarter-wave plate of zeroth order for wavelength 157 nm has a thickness of 39 mm when made from calcium fluoride of retardation 10 nm/cm, and a thickness of 15.7 mm when made from barium fluoride with a retardation of 25 nm/cm. In the case of deviations in the retardation with material charge—for example owing to strain birefringence caused by production—the required thickness changes in proportion to the deviation in the retardation. Plates of such thickness can be produced with the typical dimensions of lenses, currently up to approximately 300 mm in microlithography optics. They can be mounted or supported using the existing technology for lenses.

A corresponding quarter-wave plate of zeroth order for 157 nm made from magnesium fluoride has a thickness of only 5.5 μm (compare U.S. Pat. No. 6,084,708 B). The problem of stable support can be solved by wringing to a thicker element such as, for example, a beam splitter prism. However, it remains a problem to produce such a thin crystal plate with diameters of over 100 mm (compare DE 197 04 936 A). A quarter-wave plate of twentieth order also has a thickness of only approximately 0.22 mm. The deviation from the accurate quarter-wave retardation owing to thickness variation has precisely the same relationship in the case of plates of zeroth or higher order. Consequently, with magnesium fluoride a thickness deviation of only 0.5 μm is attended by a phase deviation of approximately 20% that cannot be used.

In the case of the inventive retardation plate of zeroth order made from calcium fluoride, a phase error of 2% likewise corresponds to a thickness error of likewise 2%. However, this 2% is 0.8 mm owing to the thickness of 39 mm. The normal production of optical elements is much more precise, and so the thickness constitutes no problem at all in production. The same holds for the quarter-wave plate made from barium fluoride, which is approximately half as thick. There is thus no reason stated here to make use of plates of higher order, although they are of course also possible.

This permissible thickness tolerance now yields the possibility of processing the end faces of the retardation plate as functional faces with refractive or diffractive action. The exit face is preferably suitable for this purpose, since the propagation of light should be performed inside the retardation plate largely in the axial direction (that is to say substantially parallel to <110>).

Up to a sine of the aperture angle (numerical aperture) of 0.2, the loss in the linear polarization degree is below 2% for a 157 nm half-wave plate made from calcium fluoride, and it still remains below 0.1% up to an NA of 0.15.

A half-wave plate of zeroth order made from magnesium fluoride certainly permits a numerical aperture of up to 0.4 of equal quality. However, for plates of higher order the angular acceptance reduces rapidly and is only NA 0.1 for a half-wave plate of twentieth order.

By contrast with magnesium fluoride, the inventive materials of the retardation plates thus really do offer a larger angular acceptance. In the case of these angles, because of the birefringence properties that deviate for other main axes and can be disadvantageous specifically in the case of lenses, the birefringence varying in the majority over the azimuth angle also still plays no role.

In conventional optical designs, specifically in illumination systems and projection objectives in microlithography, it is not plane plates of centimeter thickness that are provided for retardation plates, but individual plates of millimeter thickness, or they are provided as a negligibly thin layer on beam splitter prisms and the like. In all areas of these designs, however, where the beam angles lie in the above named region, the plane plates of centimeter thickness can, however, easily be incorporated into the design with corrections that are easily possible for the person skilled in the art. He is aided in this task by the fact, as mentioned above, that the end faces are even to a certain extent accessible as functional and correction means.

The applicant's EP 1 102 100 A exhibits a microlithographic catadioptric projection objective having a polarization beam splitter cube at which the beam path is largely collimated. A quarter-wave plate is required between this and the concave mirror. As thick plate according to the invention, it can be separated and removed from the thick, virtually planoconvex, lens in front of the concave mirror, also simultaneously with a removal for the 157 nm wavelength.

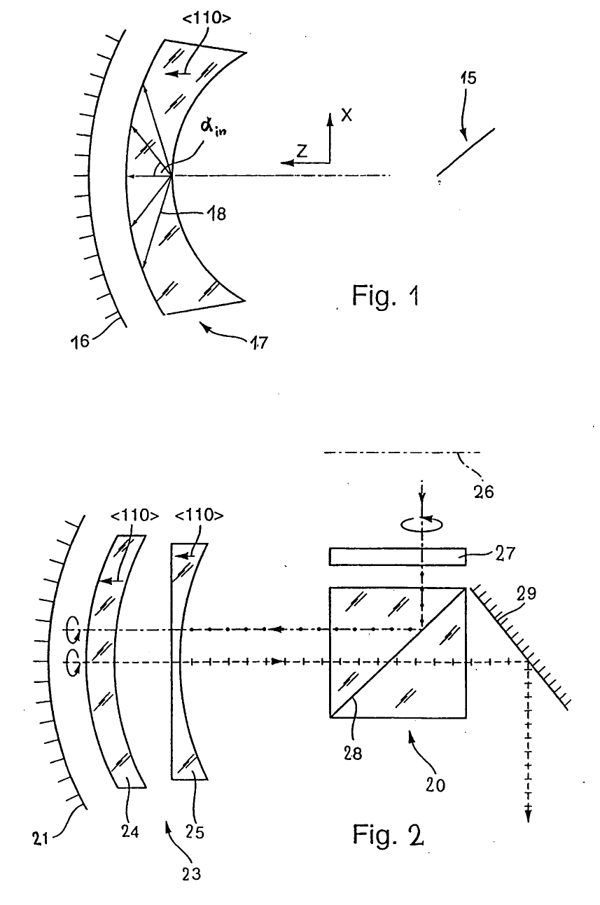

With the aid of FIG. 1, another embodiment of a catadioptric projection objective will be explained in the case of which a retardation element 17 in the form of a twice-penetrated λ/4 retarder is arranged between the beam splitter 15 and the concave mirror 16. This is a lens, arranged in the vicinity of the concave mirror, made from <110>-oriented calcium fluoride crystal that is in the shape of a meniscus overall and has a negative refracting power. The negative lens 17 arranged in the vicinity of the pupil has a dual function. On the one hand, as optical lens it supports together with the concave mirror 16 the chromatic correction of the projection objective. At the same time, it acts as a λ/4 retardation element having a retardation effect that is largely constant over the entire pupil or varies only slightly. It has been recognized that a largely constant distribution of the retardation over the pupil can be achieved wherever the (axial) thickness d of the retardation element (in the z-direction) is optimized as a function of the radial distance x from the optical axis such that the light path of the rays inside the retardation element between the entry of light and exit of light is larger, the larger the angle αᵢₙ between the beam and the optical axis of the retardation element or the <110>-direction running parallel to said axis. The adaptation is ideally such that the parabolic decrease in the intrinsic birefringence in the event of deviation from the <110>-direction is largely or completely compensated by the increase in thickness.

The beam splitter 15 can be a geometric beam splitter with one or more deflecting mirrors, or a physical beam splitter with a polarization-selectively active beam splitter surface.

A bundle of beams 18 at the center of the retardation element 17 is considered in order to detect the ideal curvature in the center region of the retardation element. The condition may be set up for all beams that the optical path length in the material is λ/4. A surface is thereby defined that is defined in two-dimensional space by the equations

X=(λ/4*sin(αᵢₙ)/Δn(αᵢₙ) and

Z≡d(x)=(λ/4*cos(αᵢₙ)/Δn(αᵢₙ)

Here, Δn is the difference in refractive index between the medium (normally air) surrounding the retardation element and the material of the retardation element, αᵢₙ is the angle between the optical axis or the <110>-axis and the respectively considered beam 18, and d(x) is the thickness as a function of the radius x of the retardation element. This calculation yields a somewhat parabolic profile of the thickness in the radial direction of the retardation element, that is approximately implemented in the case of the negative meniscus lens 17, taking account of the curvatures, ideal for optical reasons, of the entrance face and exit face.

If the resulting lens thickness is regarded as unfavorable, it is also possible to distribute the retardation over a plurality of retardation lenses or combinations of retardation lenses and retardation plates whose overall thickness can be determined, for example, in accordance with the above equations (compare FIG. 2).

In order to be able to obtain optimum use from this aspect of the invention, the combined lenses/retardation element should be arranged in a region with the smallest possible angle of incidence. Ideally, the maximum angle of incidence in air should not be greater than approximately 39°, since otherwise a crystallographically induced four-wave character of the retardation as a function of crystal direction can become noticeable. It is likewise favorable when the curvature of the lens is made smaller the smaller the angle αᵢₙ is. The sum of the lens thicknesses should correspond approximately to the corresponding thickness of a λ/4 retardation element consisting of the material. Small corrections of the overall thickness in order to adapt the retardation effect can be advantageous. For example, it can be more favorable when the retardation effect is set more accurately for edge beams than for central beams. This can lead to a homogenization of the intensity distribution after twofold passage through the retardation element.

The inventive aspect also permits corrective measures for the case wherein the ideal overall thickness determined is too large or too small. For example, it is possible to attenuate the retardation when two <110>-cut lenses of approximately the same thickness are rotated relative to one another by 45° with reference to the <110> axis. If the overall thickness is too small, it is possible, for example, to provide an additional, plane-parallel plate made from <110>-oriented material. It is to be ensured here, in particular, that the inclination of the beams is not too large.

An embodiment of a catadioptric projection objective with a polarization-selective beam splitter 20 in the form of a beam splitter cube is explained with the aid of FIG. 2. In this embodiment, the polarization rotation direction 23 acting as a λ/4 retarder is arranged between the beam splitter 20 and the concave mirror 21. The retardation element 23, of multipartite design, comprises two negative meniscus lenses 24, 25 that consist in each case of one <110>-oriented calcium fluoride crystal. The overall axial thickness of the lenses corresponds in the central region close to the axis to the corresponding thickness of a λ/4 retardation plate (for example, approximately 36 mm for calcium fluoride given an operating wavelength of 157 nm), and increases parabolically in the radial direction in order to smooth out the retardation effect over the entire lens cross section of the lenses 24, 25 arranged in the region of the pupil.

The projection objective is designed for operating with a circularly polarized input light, and has between the object plane 26 and beam splitter 20 a λ/4 plate 47 for converting the input light into a light that is s-polarized with reference to the beam splitter surface 28. This plate 27 can consist, for example, of <110>-oriented calcium fluoride. The light penetrates two lenses 24, 25 and is converted because of the retardation effect thereof, into circularly polarized light that is reflected by the concave mirror 21 and runs back through the retardation device 23. After renewed passage through the retardation lenses 24, 25, the light is p-polarized with reference to the beam splitter layer 28, and penetrates the latter without loss in the direction of a deflecting mirror 29 that deflects the light in the direction of the object plane. This explains, for example, that the λ/4 retarder, which is functionally necessary with such systems, between the beam deflection device 20 and concave mirror can be formed by one or more lenses with a suitable retardation effect. The λ/4 plate conventionally required between beam splitter and concave mirror can therefore be eliminated.

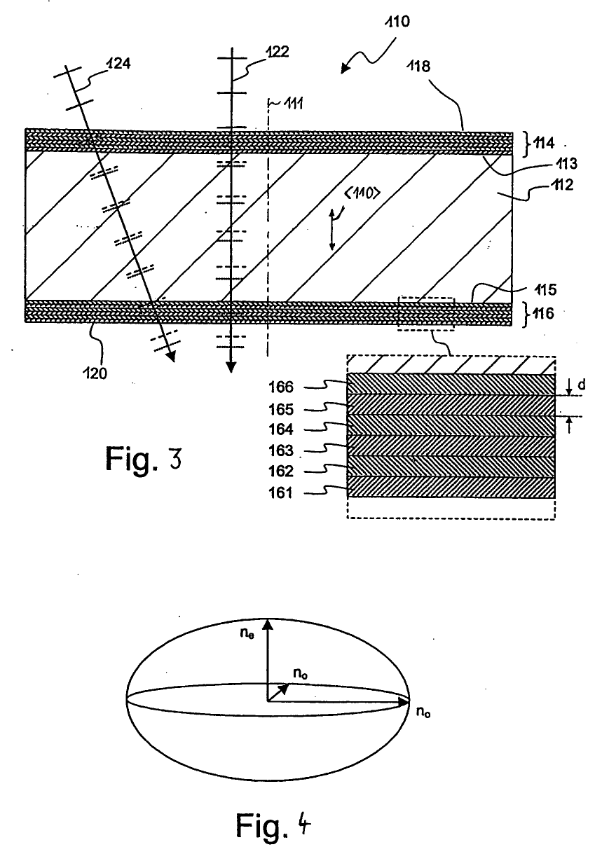

FIG. 3 shows a retardation plate, denoted overall by 110, in a section along its symmetry axis. The retardation plate 110 has a fluorspar (calcium fluorite) crystal plate 112, whose optical axis indicated by 111 is aligned at least approximately in the direction of the <110> crystal axis running perpendicular to the entry and exit face of the retardation plate.

An upper dielectric layer structure 114 and a lower dielectric layer structure 116 are respectively applied to the upper and lower sides 113 and 115 of the disc-shaped fluorspar crystal plate 112. As can be seen from the enlarged representation in FIG. 3, the lower layer structure 116 consists of a sequence of six dielectric layers 161, 162, . . . , 166 with an alternating refractive index. In the exemplary embodiment being represented, the layers 161, 163 and 165 have a first refractive index n₁, whereas the layers 162, 164 and 166 have a second refractive index n₂ which is different from the refractive index n₁. All the layers 161, 162, . . . , 166 have the same thickness d, which, in the exemplary embodiment being represented, is 1/10 of the wavelength of the incident light. If the retardation plate 110 is designed, for example, for ultraviolet light with the wavelength λ=157 nm, then the thickness d is only about 15 nm. For the sake of clarity, the thickness of the individual layers 161 to 166 is consequently represented on a significantly exaggerated scale in FIG. 3.

The lower layer structure 116 is form-birefringent because of the alternating sequence of layers 161 to 166 with high and low refractive index. This means that the lower layer structure 116 has a differing refractive index, depending on the polarisation direction of the light, for light incident obliquely to the layer planes. FIG. 4 shows a refractive-index ellipsoid for the lower layer structure 116. It is clear from this that light which is polarised parallel to the layer planes is exposed to the refractive index no for the ordinary beam, whereas light which is polarised perpendicularly to the layer planes is exposed to the refractive index nₑ for the extraordinary beam, with nₑ<nₒ.

The relationship between the refractive indices nₑ and nₒ, on the one hand, and the refractive indices n₁ and n₂ of the layers 161, 162, . . . , 166 as well as the layer thickness d, on the other hand, is described for example in the aforementioned U.S. Pat. No. 6,384,974.

Since light incident normally on the layer structure is always polarised parallel to the layer planes, the lower layer structure 116 is not birefringent for such a light beam. However, the larger the angle is between the layer planes and the light passing through, the stronger is the birefringent effect of the lower layer structure 116—at least for unpolarised or circularly polarised light.

The upper layer structure 114 is constructed precisely like the lower layer structure 116, so that the comments made above correspondingly apply here.

In FIG. 3, the birefringent effect of the upper and lower layer structures 114 and 116, as well as the fluorspar crystal plate 112, is illustrated highly schematically for two linearly polarised light beams 122 and 124. The light beam 122 in this case strikes the entry face 118 of the retardation plate 110 in such a way that it passes normally through the upper layer structure 114. Owing to this normal transmission, as mentioned above, the light beam 122 is not exposed to any birefringence in the upper layer structure 114. As a consequence of this, splitting of the wavefronts does not take place there either. As soon as the wavefronts enter the fluorspar crystal plate 112, however, the incident wave is split in the way typical of birefringence into an ordinary wave and an extraordinary wave, which are respectively illustrated in FIG. 3 as dashed and dotted wavefronts, since the propagation direction is parallel to the <110> axis of the crystal This splitting of the wavefronts, and the concomitant increase in the phase difference, ends as soon as the wavefronts enter the lower layer structure 116, since the beam 122 is not exposed to any birefringence there. The emerging beam 122 has the desired phase difference of λ/4 or λ/2, corresponding to the thickness of the layer 112, between the two mutually orthogonally polarised components.

The second beam 124 is inclined relative to the first beam 122 in such a way that it strikes the entry face 118 of the retardation plate 110 at a large angle. For this angle of incidence, both the upper and lower layer structures 114 and 116 have a strongly birefringent effect, whereas the fluorspar crystal plate 112 lying in-between is hardly at all birefringent for this angle of incidence since this propagation direction lies at a large angle to the <110> axis of the crystal. The splitting of the wavefronts introduced by the upper layer structure 114 is therefore substantially preserved during transmission through the fluorspar crystal plate 112, until further splitting of the wavefronts takes place in the lower layer structure 116. As can be seen in FIG. 3, the layer structures 114 and 116 are configured in such a way that the overall splitting of the wavefronts, that is to say the phase difference introduced by the retardation plate 110 for the different polarisation directions, corresponds approximately in the case of the beam 124 incident obliquely to the optical axis 111 to the phase difference which has been introduced by the retardation plate 110 for the beam 122 incident parallel to the optical axis 111. In this way, the retardation plate 110 makes it possible to produce an approximately constant phase difference for light beams over a large range of angles of incidence.

The documents cited are also intended to be part of this application in full. The invention is particularly advantageous at 157 nm and in the neighborhood thereof, since the intrinsic birefringence is particularly high here, but its application is also appropriate for the 193 nm microlithography systems and other optical systems, for example inspection systems.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A retardation element having an optical axis and consisting of an alkaline-earth metal fluoride crystal having a <110> crystal axis, the optical axis pointing approximately in the direction of the <110> crystal axis of the crystal or a main crystal axis equivalent thereto.

2. The retardation element as claimed in claim 1, wherein the alkaline-earth metal fluoride crystal is one of a calcium fluoride crystal and a barium fluoride crystal.

3. The retardation element as claimed in claim 1, wherein the retardation element is a retardation plate having an entry face for incident light and an exit face for exiting light and an optical axis substantially perpendicular to the entry and exit faces.

4. The retardation element as claimed in claim 3, wherein the retardation element is one of a λ/2 retardation plate and a λ/4 retardation plate.

5. The retardation element as claimed in claim 4, wherein the retardation plate is one of a λ/2 retardation plate of zeroth order and a λ/4 retardation plate of zeroth order.

6. The retardation element as claimed in claim 1, wherein the retardation element is a retardation plate, the retardation plate having a thickness variation of at least of up to 2% and up to 1 mm.

7. The retardation element as claimed in claim 1, wherein the retardation element is a retardation plate having an entry face for incident light and an exit face for exiting light, wherein at least one of the entry face and the exit face is provided with a refractively or diffractively active structure or shape.

8. The retardation element as claimed in claim 1, wherein the retardation element has a diameter in the range from 50 to 300 mm.

9. The retardation element as claimed in claim 1, wherein the retardation element is mounted in an unstressed fashion.

10. The retardation element as claimed in claim 1, wherein the retardation element is designed as a lens element with a positive or negative refracting power.

11. The retardation element as claimed in claim 1, wherein the retardation element is designed as a meniscus-shaped lens with a negative refracting power.

12. The retardation element as claimed in claim 1, wherein the retardation element has two optical faces, a shape of the optical faces and an installation position of the retardation element in an optical system being adapted to one another in such a way that the light path of beams inside the retardation element is larger between the optical faces the larger the angle is between a penetrating beam and the optical axis of the retardation element.

13. The retardation element as claimed in claim 1, the retardation element being a lens made from a cubic crystal material with intrinsic birefringence and having a radius and a thickness, wherein as a function of the radius, the thickness has an approximately parabolic profile with radially increasing thickness.

14. A catadioptric projection objective, having at least one retardation element as claimed in claim 1.

15. A catadioptric projection objective for imaging a pattern arranged in an object plane of the projection objective into the image plane of the projection objective arranged between the object plane and the image plane, comprising:
a catadioptric objective part having a concave mirror and a beam splitter with a beam splitter surface;
a retardation device having the action of a λ/4 plate and being arranged between the beam splitter surface and the concave mirror;
the retardation device having at least one retardation element that is designed as a lens and consists of a cubic crystal material having intrinsic birefringence, the optical axis of the retardation element being aligned approximately in the direction of a <110> crystal axis of the crystal.

16. The projection objective as claimed in claim 15, wherein the retardation element is made of one of a calcium fluoride crystal and a barium fluoride crystal.

17. The projection objective as claimed in claim 15, wherein at least one retardation element is designed as a meniscus-shaped lens with negative refracting power.

18. The projection objective as claimed in claim 15, wherein at least one retardation element has two optical faces, the shape of the optical faces and the installation position of the retardation element being adapted to one another in such a way that the light path of beams inside the retardation element is larger between the optical faces the larger the angle is between a penetrating beam and the optical axis of the retardation element.

19. The projection objective as claimed in claim 15, wherein the retardation element has a radius and a total thickness and wherein, as a function of the radius, the total thickness of the retardation element has an approximately parabolic profile with radially increasing total thickness.

20. The projection objective as claimed in claim 15, wherein the retardation device is arranged in the vicinity of a pupil plane of the projection objective.

21. The projection objective as claimed in claim 15, wherein the retardation device is arranged in the vicinity the concave mirror.

22. The projection objective as claimed in claim 15, wherein no λ/4 plate is arranged between the beam splitter and the concave mirror.

23. A microlithography projection exposure machine, comprising an illumination system and a projection objective for imaging a pattern-bearing mask onto a photosensitive substrate, wherein the microlithography projection exposure machine has at least one retardation element as claimed in claim 1.

24. The microlithography projection exposure machine as claimed in claim 23, wherein the illumination system has a retardation element as claimed in claim 1.

25. A method for producing semiconductor components comprising utilizing a microlithography projection exposure machine as claimed in claim 23.

26. A retardation plate comprising:
a birefringent crystal plate, the crystal plate having an entry face for incident light and an exit face for emerging light and an optical axis; wherein
the crystal plate consists of an alkaline-earth metal fluoride and has a <110> crystal axis;
the optical axis of the retardation plate is aligned at least approximately in the direction of the <110> crystal axis or of a substantially equivalent principal crystal axis; and
a form-birefringent layer structure is applied to at least one of the entry face and the exit face.

27. The retardation plate according to claim 26, wherein the form-birefringent layer structure is configured as a periodic sequence of at least two dielectric layers with alternating refractive indices.

28. The retardation plate according to claim 27, wherein a thickness (d) of the layers is less than the wavelength for which the retardation plate is designed.

29. The retardation plate according to claim 28, wherein the thicknesses (d) of the layers are less than ⅕ of the wavelength for which the retardation plate is designed.

30. The retardation plate according claim 27, wherein all the layers have the same thickness (d).

31. A retardation plate comprising:
a birefringent crystal plate, the crystal plate having an entry face for incident light and an exit face for emerging light and an optical axis perpendicular to the entry face and the exit face; wherein
the crystal plate consists of one of calcium fluoride (CaF₂) and barium fluoride (BaF₂) fluoride and has a <110> crystal axis;
the optical axis of the retardation plate is aligned at least approximately in the direction of the <110> crystal axis or of a substantially equivalent principal crystal axis; and
a form-birefringent layer structure is applied to at least one of the entry face and the exit face.

32. A retardation element having an optical axis and consisting of one of a calcium fluoride crystal and a barium fluoride crystal having a <110> crystal axis, the optical axis pointing approximately in the direction of the <110> crystal axis of the crystal or a main crystal axis equivalent thereto, wherein:
the retardation element is a retardation plate having an entry face for incident light and an exit face for exiting light and an optical axis substantially perpendicular to the entry and exit faces; and
the retardation element is one of a λ/2 retardation plate and a λ/4 retardation plate.
